(19) United States
(12) Patent Application Publication
(10) Pub. No.: US 2017/0345046 A1
(43) Pub. Date: Nov. 30, 2017

(54) POINT-OF-SALE PROCESSING OF MOBILE MANUFACTURER BARCODE

(71) Applicant: Samsung Pay, Inc., Burlington, MA (US)

(72) Inventor: Venkatesh Raju, San Jose, CA (US)

(73) Assignee: Samsung Pay, Inc., Burlington, MA (US)

(21) Appl. No.: 15/603,667

(22) Filed: May 24, 2017

Related U.S. Application Data
(60) Provisional application No. 62/341,036, filed on May 24, 2016.

(51) Int. Cl. G06Q 30/02; G06K 7/14

(52) U.S. Cl. CPC G06Q 30/0238; G06K 7/1413

(57) ABSTRACT

A method and mobile device processing a mobile manufacturer coupon is provided. A barcode of a mobile manufacturer coupon is received at an electronic point-of-sale system from a mobile electronic device. A determination of whether redemption criterion for the coupon is satisfied is made at the electronic point-of-sale system. An audio acknowledgement signal is emitted from the electronic point-of-sale system and received by the electronic mobile device if the redemption criterion is satisfied.

### CROSS-REFERENCE TO RELATED APPLICATIONS

The present application claims benefit of U.S. Provisional Application No. 62/341,036 filed May 24, 2016 which is incorporated by reference in its entirety.

### TECHNICAL FIELD

The present disclosure relates to the field of electronic barcode processing.

### BACKGROUND

It is known to process promotional coupons in connection with point of sale transactions. The present disclosure relates to limitations in the field of electronic barcode processing, such as for electronic point-of-sale transactions. More particularly, there are known limitations relating to electronic point-of-sale acknowledgement of redemption of mobile manufacturer coupons.

### SUMMARY

The present disclosure provides a system for and method of point-of-sale (POS) bar code processing acknowledgement of electronic mobile manufacturer coupon redemption. In accordance with an embodiment of the present disclosure, a method of processing an electronic mobile manufacturer coupon is provided. A barcode of a mobile manufacturer coupon is received at an electronic point-of-sale system from a mobile electronic device. A determination of whether redemption criterion for the coupon is satisfied is made at the electronic point-of-sale system. An acknowledgement, such as an audio acknowledgement signal, is emitted from the electronic point-of-sale system if the redemption criterion is satisfied, the audio acknowledgement signal being capable of being received and interpreted by the mobile electronic device. These and other aspects of the present disclosure are described herein.

### BRIEF DESCRIPTION OF THE DRAWINGS

The present disclosure is described with respect to particular exemplary embodiments thereof and reference is accordingly made to the drawings in which:

FIG. 1 illustrates an example of a paper manufacturer coupon;

FIG. 2 illustrates an example of a mobile manufacturer coupon for use in connection with embodiments of the present disclosure; and

FIG. 3 illustrates a system for point-of-sale acknowledgement of mobile manufacturer coupon redemption in accordance with an embodiment of the present disclosure.

### DETAILED DESCRIPTION

Mobile manufacturer coupons (MMC) are a form of promotional coupons for mobile devices issued by manufacturers and their affiliates. They are essentially equivalent to paper-based manufacturer coupons, with the exception that they are not printed on paper but distributed electronically to shoppers via websites, mobile apps or social media. A mobile manufacturer coupon can be received and stored by mobile electronic devices, such as smart phones and tablet computers, using an appropriate mobile software application program. Mobile manufacturer coupons can also be displayed and redeemed by mobile electronic devices. Like conventional paper-based coupons, mobile manufacturer coupons generally have an associated barcode that serves to identify the particular coupon or promotion represented by the coupon.

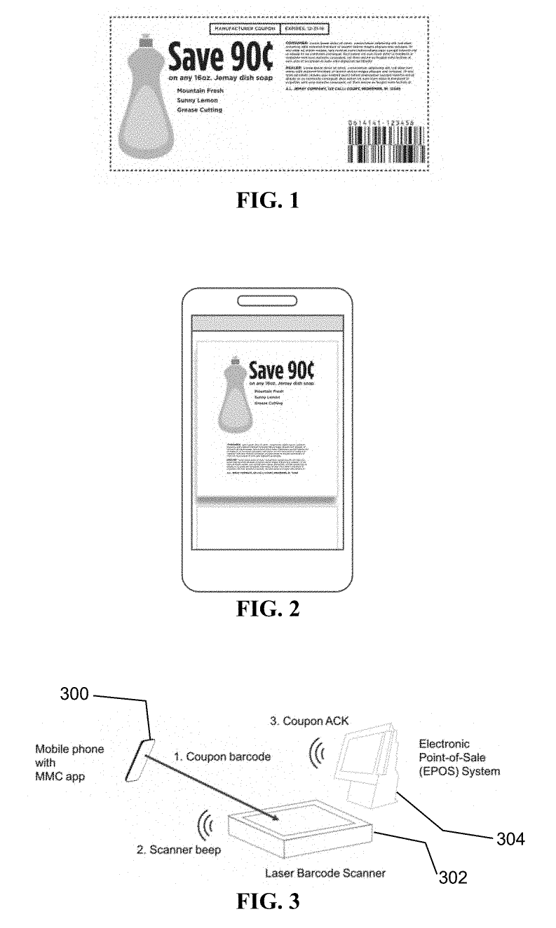

The paper coupon shown in FIG. 1 in MMC form may be distributed via a mobile application and displayed by a mobile device as shown in FIG. 2.

Redeeming a mobile manufacturer coupon at a retail checkout point-of-sale (POS) is much like redeeming a paper coupon. The shopper or clerk scans the barcode of a displayed coupon at the point-of-sale scanner. In some markets, such as the United States, digital coupon standards prohibit the display of the barcode on the screen. However, the barcode may alternatively be transmitted by the shopper's mobile device to the POS scanner using, for example, beaming technology (also referred to as pulsed light simulated barcode) such as described in U.S. Pat. No. 6,685,093, the entire contents of which are hereby incorporated by reference.

The use of mobile manufacturer coupons has significant advantages to both the consumer and the issuing manufacturer. For the consumer, it eliminates the need to cut out the coupons from a newspaper or other coupon booklet, and for the issuer, it can provide a direct relationship with the consumers as the mobile coupons can be tracked to individual users via the mobile device. This direct relationship enables the manufacturer to better anticipate the needs of the individual shopper and offer more relevant coupons than would be otherwise possible.

An important aspect of establishing or maintaining the consumer relationship is for the manufacturer to know when a coupon is successfully redeemed. This is referred to closing the loop at the point-of-sale.

Redemption of mobile manufacturer coupons can be identified and tracked by correlating a redemption record for the transaction from a retailer's point-of-sale system with the mobile device's redemption record for the coupon. This can involve having all involved retailer locations periodically transmit their coupon redemption records to a centralized clearing house, e.g. nightly, and the clearing house sending the combined redemption records to another party (e.g. a mobile app provider) for correlation with the mobile device redemption records. Disadvantages of this approach include the periodic transmission required from each retailer location, as well as a delay in determining coupon redemption.

The present disclosure is directed toward providing an improved solution for identifying and tracking redemption of mobile manufacturer coupons.

In accordance with an embodiment of the present disclosure, an audio-based acknowledgement of successful coupon redemption by a POS is received by a mobile phone application. In accordance with a further embodiment, an audio-based indication of attempted, but failed, coupon redemptions by a POS is received by a mobile phone application.

The present disclosure provides a real-time acknowledgement of the coupon redemption by the electronic point-of-sale system directly back to the shopper's mobile phone using an audio acknowledgement message. An embodiment of a system for such coupon redemption acknowledgement is shown in FIG. 3.

As shown in FIG. 3, a shopper can redeem a mobile coupon on a mobile device 300 at a point-of-sale by initiating transmission of the coupon's barcode (1). This can be via pulsed light beaming to a barcode scanner 302 of an electronic point-of-sale (EPOS) system 304. The barcode scanner can then optionally emit a beep (2) or other sound upon successful decode of the barcode. This optional beep or sound is a human-perceptible audio signal that indicates the barcode scan was successful.

The EPOS system 304 then validates the coupon and determines if the criteria for the coupon are met. Such criteria can include, for example, the EPOS system 304 determining that the coupon is for an item of merchandise or a service presently being purchased by the shopper and that the coupon is currently valid (e.g., the coupon or promotion has not yet expired).

If the transaction meets all the criteria, the EPOS transmits an audio acknowledgement signal (3). This audio acknowledgement signal is received via a microphone of the mobile device 300 and is decoded by a mobile device application program. The audio acknowledgement signal preferably comprises emitted sound waves having characteristics expected by the mobile phone application to indicate successful redemption of the coupon. For example, the emitted audio signal can include a predetermined tone or sequence of tones, which may or may not be human perceptible. The emitted audio signal is preferably distinguishable from expected normal background sound and from the optional beep emitted to indicate a successful barcode scan.

If the coupon is rejected, e.g., because one or more criteria are not satisfied for redemption, the EPOS system 304 may transmit an audio negative acknowledgement. This non-acknowledgment signal informs the mobile phone application that the coupon was rejected. The audio non-acknowledgment signal preferably comprises emitted sound waves having characteristics expected by the mobile phone application to indicate a failed attempt at redemption of the coupon. For example, the emitted audio signal can include a predetermined tone or sequence of tones, which may or may not be human perceptible. This emitted audio signal is preferably distinguishable from expected normal background sound and from the optional beep emitted to indicate a successful barcode scan.

In an embodiment, the customer is informed by the EPOS system 304 or the mobile device 300 as to whether the coupon is accepted. If the coupon is accepted, this indicates that the transaction was completed, or will be completed, with the coupon or promotion being incorporated into the transaction. Otherwise, if the coupon is not accepted, the shopper can decide whether to attempt to redeem a different coupon or to discontinue the transaction with respect to the affected merchandise or service.

After the mobile device 300 receives the audio acknowledgement or non-acknowledgement, the mobile application can transmit this redemption information to the manufacturer or to a centralized processing facility, e.g., by wireless telephone communication, text message, etc., for further processing by the manufacturer or on behalf of the manufacturer or its affiliates. This transmission of the redemption information can be contemporaneous with the transaction (i.e. in “real-time”) or it can take place a later time, e.g., in batches of transaction data.

According to embodiments of the present disclosure, the use of an audio message from the EPOS back to the phone functions to “close the loop.” Mobile devices, such as smart phones and tablets, are generally configurable to listen and process audio received via the built-in microphone, therefore the audio message reception aspect of this disclosure is readily implemented on the mobile device. A significant portion of existing EPOS systems are based on PC platforms and most have built-in speakers. The audio message transmission aspect is therefore also readily implementable and in most cases requires no additional hardware.

The foregoing detailed description of the present disclosure is provided for the purposes of illustration and is not intended to be exhaustive or to limit the disclosure to the embodiments disclosed. Accordingly, the scope of the present disclosure is defined by the appended claims.

What is claimed is:

1. A method of processing a mobile manufacturer coupon comprising steps of:
receiving from a mobile electronic device a barcode of a mobile manufacturer coupon at an electronic point-of-sale system;
determining at the electronic point-of-sale system whether redemption criterion for the coupon is satisfied; and
emitting an audio acknowledgement signal from the electronic point-of-sale system if the redemption criterion is satisfied, the audio acknowledgement signal being capable of being received and interpreted by the mobile electronic device.

2. The method according to claim 1, wherein the barcode is received at the electronic point-of-sale system by the mobile electronic device emitting a pulsed light simulated barcode.

3. The method according to claim 1, wherein the redemption criterion includes purchase of merchandise or service corresponding to the coupon and the coupon being valid.

4. The method according to claim 1, further comprising emitting an audio non-acknowledgement signal from the electronic point-of-sale system if the redemption criterion is not satisfied, the audio non-acknowledgement signal being capable of being received and interpreted by the mobile electronic device.

5. A method of processing a mobile manufacturer coupon comprising steps of:
transmitting from a mobile electronic device a barcode of a mobile manufacturer coupon at an electronic point-of-sale system;
receiving, at the mobile electronic device, an audio acknowledgement signal from the electronic point-of-sale system if coupon redemption criterion is satisfied, the audio acknowledgement signal being received and interpreted by the mobile electronic device; and
receiving, at the mobile electronic device, an audio non-acknowledgement signal from the electronic point-of-sale system if the coupon redemption criterion is not satisfied, the audio non-acknowledgement signal being received and interpreted by the mobile electronic device.

6. The method according to claim 5, wherein the barcode is transmitted to the electronic point-of-sale system by the mobile electronic device emitting a pulsed light simulated barcode.

7. The method according to claim 5, wherein the redemption criterion includes purchase of merchandise or service corresponding to the coupon and the coupon being valid.

8. The method according to claim 5, wherein the audio non-acknowledgement signal is distinguished by the mobile electronic device from the audio acknowledgement signal.

9. A mobile electronic device, comprising:
a transmitter transmitting from the mobile electronic device a barcode of a mobile manufacturer coupon at an electronic point-of-sale system to process the mobile manufacturer coupon;
a built-in speaker receiving, at the mobile electronic device, an audio acknowledgement signal from the electronic point-of-sale system if coupon redemption criterion is satisfied, the audio acknowledgement signal being received and interpreted by the mobile electronic device; and
the built-in speaker receiving, at the mobile electronic device, an audio non-acknowledgement signal from the electronic point-of-sale system if the coupon redemption criterion is not satisfied, the audio non-acknowledgement signal being received and interpreted by the mobile electronic device.

10. The mobile electronic device according to claim 9, wherein the barcode is transmitted to the electronic point-of-sale system by the mobile electronic device emitting a pulsed light simulated barcode.

11. The mobile electronic device according to claim 9, wherein the redemption criterion includes purchase of merchandise or service corresponding to the coupon and the coupon being valid.

12. The mobile electronic device according to claim 9, wherein the audio non-acknowledgement signal is distinguished by the mobile electronic device from the audio acknowledgement signal.

13. The mobile electronic device according to claim 9, further comprising a wireless transmitter transmitting redemption information to a manufacturer centralized processing facility.

14. The mobile electronic device according to claim 13, wherein transmitting redemption information to the manufacturer centralized processing is done on a real-time basis.

15. The mobile electronic device according to claim 13, wherein transmitting redemption information to the manufacturer centralized processing is done on a batch basis.
